(19) United States
(12) Patent Application Publication
(10) Pub. No.: US 2021/0388811 A1
(43) Pub. Date: Dec. 16, 2021

(54) Solar Supplemental Power Source

(71) Applicant: Kannan Gopalakrishnan, Arlington, VA (US)

(72) Inventor: Kannan Gopalakrishnan, Arlington, VA (US)

(21) Appl. No.: 17/288,520

(22) PCT Filed: Oct. 28, 2019
(86) PCT No.: PCT/US2019/058395

§ 371 Date: Apr. 24, 2021

Related U.S. Application Data
(60) Provisional application No. 62/751,615, filed on Oct. 27, 2018.

(51) Int. Cl. F03B 13/22

(52) U.S. Cl. CPC F03B 13/22; H02S 10/10

(57) ABSTRACT

This invention discloses a prime mover, preferably an electro-mechanical device (FIG. 2) with an end goal for generating electricity, which can operate even when the sun light based solar energy is not available. It comprises a wheel structure imparted with multiple arms (22) and arm loads (24) along with the feeder box (38) to cycle through the side tank (30). The feeder box regulates the arm movement within the feeder box (38) using the treaded guides (45). Due to the buoyant and gravitational forces the unbalanced arm loads (24) cause the imbalance in the wheel structure and rotate the entire wheel structure along the guided track. This prime mover can be used primarily for generating electricity by connecting it to an electrical generator (60).

### TECHNICAL FIELD

This invention is an electro-mechanical device. It relates to a prime mover, which can be used in many industrial applications to drive the machineries. A primary use of this invention is to drive the electrical generator and in turn to generate the electrical power.

### BACKGROUND ART

There are many inventions which are used as prime movers, since the quest for automation started, and they mostly convert some form of energy from the resources into mechanical energy, that can be used as a driving force for operating the machines. They depend on few resources, that are available naturally or derived from other raw materials.

### RELEVANT PRIOR ART INCLUDES

U.S. Pat. 2009/0091135 A1—Apparatus and method for generating electric power from a sub-surface water current

U.S. Pat. No. 4,527,618—Solar energy storage and distribution system with heat pump assist

U.S. Pat. 2010/0207388 A1—Supplemental power source

U.S. Pat. 2011/0117974 A1—Supplemental accessory system for portable electronic devices

U.S. Pat. 2011/0109091 A1—Counter rotation subsurface current generator

### Technical Problem

There are some disadvantages associated with the resources used up in these energy conversion processes, deployed by the prior arts like the resources being not renewable, rarely available, seasonal, not environmentally friendly, hazardous, radioactive, pollution prone and so on. Over the course of time, they consume and deplete the raw resources. Even the renewable ones are consumed at a faster rate than that can ever be produced.

### Technical Solution

This invention overcomes most of the disadvantages as listed above and presents a pollution free and a manifold efficient solution. Further this invention delivers the continuous and consistent drive as a prime mover whereas some of the prior arts produce the drive intermittently like ocean wave energy.

### Advantageous Effects

A primary advantage of the invention is to generate electricity in a pollution free and sustainable manner.

It boasts zero emissions.

Another advantage is that this invention is highly scalable and a large-scale setup can serve the industrial power requirements.

Yet another advantage is its raw resources are sustainable and self-renewable by recycling the resource.

Further advantage is that it operates consistently and in a highly energy efficient way.

### DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate the understanding.

FIG. 1—(prior art US20090091135A1) shows the “Apparatus and method for generating electric power from a sub-surface water current”

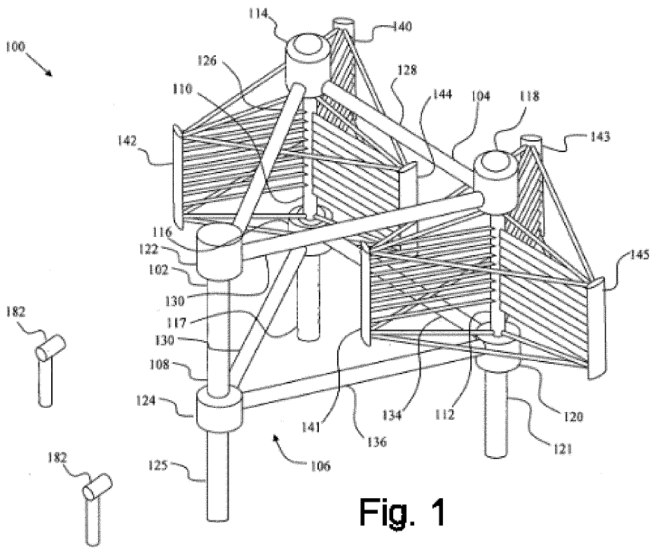

FIG. 2—shows the supplemental power source

FIG. 3—shows the feeder box

FIG. 4—shows the arm load assembly

FIG. 5—shows the side tank with the guided slot

### DRAWINGS—REFERENCE NUMERALS

22—Arm
24—Arm load
25—Arm load Outer cover
26—Arm load pack
27—Arm load mount frame
28—Arm load side cover
29—Arm load pack mount points
30—Side Tank
32—Bottom Tank
38—Feeder Box
40—Feeder Gate
41—Feeder Gate Slide
42—Feeder Valve
44—Feeder Door
45—guided slot
46—guided slot seal
48—Shaft
50—Water Level Control Box
54—Gear Box
56—Shaft Mount
60—Generator

### BEST MODE

The best mode of this invention comprises the preferred embodiment of the invention described below. Adding more features like light sensors, water level sensors, automatic gate valves, belt drives and chain drives are possible. This invention can be enhanced with rigidly or loosely coupled arm loads. The arm loads can be arranged to move in a linear or non-linear guided tracks or profiled paths. Further the arm loads can be controlled to move in a forward, reverse, reciprocal and pulsed modes.

### Mode for Invention

In accordance with a preferred embodiment of the invention, there is disclosed a machine for driving the electrical generator comprising: a wheel structure having multiple arms loaded with arm loads which move in a guided track. The side tank and the feeder box facilitate the provision of buoyant force on one end of the arm and the gravitational pull on the arm load at the other end of the arm keep the entire wheel structure rotating. The main shaft which is connected at the center of the wheel structure is connected to a gear box for providing consistent and regulated drive to the electrical generator. This invention can be linked in tandem or in parallel fashion using belt drives or chain drives to provide high torque drive to the electrical generator.

### INDUSTRIAL APPLICABILITY

The primary use of this invention is to drive the electrical generator for producing electricity. It is highly scalable and can supply the electrical power for machines ranging from small scale home appliances to large scale industrial machines.

This invention is highly scalable, zero carbon, sustainable and highly efficient machine.

This invention can be established even in remote areas where power grid is not accessible.

Further this invention can be used to drive directly the machineries like agricultural machines, locomotives and heavy equipments.

### DETAILED DESCRIPTION OF THE PREFERRED EMBODIMENTS

In the following sections, the wheel structure imparted with multiple arms 22 and arm loads 24 are briefly referred to as “wheel”. The liquid substance filled in the side tank 30 can be water or any liquid like substance depending on the requirements.

### Arm Load

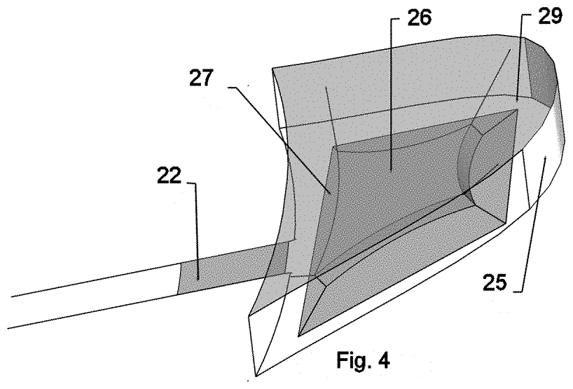

Arm load 24 as shown in FIG. 4, provides the mechanical energy due to gravitational force to rotate the wheel. The arm load side covers 28 provide the mount points for the arm load pack 26 and the protection for the arm load pack while it is moving through the feeder box 38 and the side tank 30. The arm load pack can contain water, any liquid, gel, any similar material or a combination of these materials. The liquid like arm load material may be chosen to be having a preferred specific gravity based on the experimental statistics and the requirements.

### Feeder Box

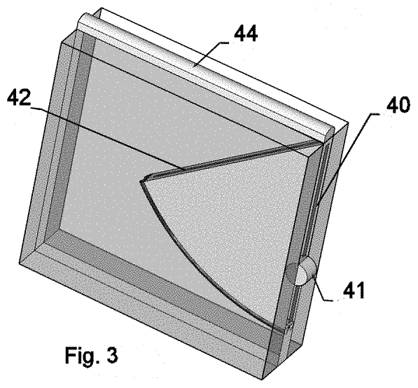

As shown in FIG. 3, Feeder box 38B feeds the arm load into the side tank 30 from the bottom of the side tank 30. The feeder box 38B has a gate 40 to capture and guide the arm load. The gate 40 can be controlled electronically or using a spring-loaded slider which slides along the arm load profile. The feeder boxes 38B and 38T have the guided slots to guide the arm while rotating the wheel. The feeder box 38T can be used optionally if the weight balancing between the arms need to be adjusted further.

### Side Tank and Bottom Tank

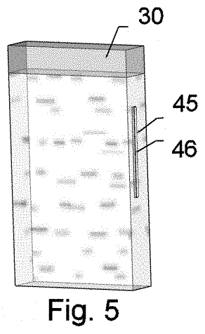

As shown in FIG. 5, Side tank that sits between the top feeder box 38T and bottom feeder box 38B has one or more guided slots. It serves the purpose of yielding for the arm 22 while the arm load 24 is moving through the side tank. The guided slot needs to be leak proof to minimize the side tank material leakage which is collected in the bottom tank 32. The bottom tank 32 is used to collect the leakage and spillage from the side tank, feeder boxes and the arm load.

### Solar Panels and Generator

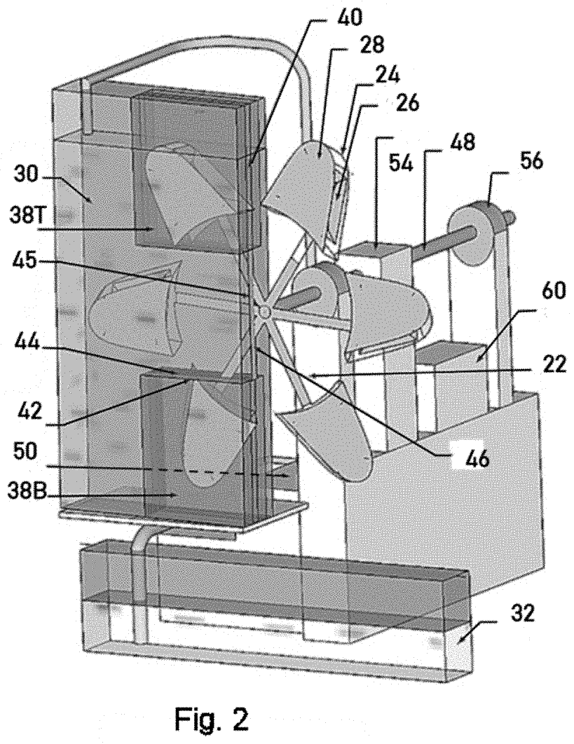

As shown in FIG. 2, A few additional components such as solar panel, gear box 54 and the generator 60 are required to achieve the end goal of generating electrical energy. The solar panel is used to recharge a battery backup which in turn is used to pump the water from the bore well into the top tank. The water level controller senses the water levels from the top tank 38T, bottom tank 38B and the top tank to replenish the water in the side tank up to the preset water level.

### Achieving the Results

Multi armed wheel with unbalanced arm loads causes imbalance in the wheel to rotate along the guided track. The arm loads are fed into the feeder box to cycle through the side tank. The feeder box regulates the arm movement within the feeder box using the treaded guides. The buoyant force on one end of the arm and the gravitational pull on the arm load at the other end of the arm keep the entire wheel structure rotating. The side tank water level is monitored by the sensors and the side tank gets filled to the preset level from the bottom reservoir and additionally from the water well if needed. All the arms are attached to the crank shaft at the center of the wheel. The rotating wheel cranks the shaft which is attached to the gear box. The gear box is controlled electronically to provide the consistent cranking to the generator shaft. The generator in turn supplies the electrical energy. The amount of electrical power generated can be adjusted by varying the arm loads.

### Alternative Embodiments

Additional wheels can be attached to the main shaft to provide more cranking power for the generator
Various arm profile designs can be deployed as needed to improve the efficiency of the system
Mini or micro level gates can be used in place of the feeder box to control the liquid flow
More sensors can be used in the feeder box to enhance the arm tracking and associated control mechanisms
Different arm load materials like gel or other materials with different specific gravity can be used
Arm loads can be arranged to move in the linear or non-linear guided paths
Arm loads can be connected to the wheel with multiple degrees of freedom

What is claimed is:

1. A prime mover mechanism (process), which can deliver usable mechanical energy arising from the difference in potential energy levels caused by the buoyant and gravitational forces in the system which can be achieved by a preferable embodiment such as an electro mechanical device (FIG. 2) comprising a wheel structure imparted with multiple arms (22) and arm loads (24) along with the feeder box (38) to cycle through the side tank (30) filled with a fluidic medium or vacuum.
(1) Means for arm loads (FIG. 4) such as solid, liquid or gas packs
(2) Rigidly or loosely coupled arm loads (24) with multiple degrees of freedom
(3) Means for guiding the arm loads (24), such as contoured tracks to guide the arms (22) and arm loads (24)
(4) Vertical or horizontal configurations of this prime mover with linear or non-linear paths
(5) Tandem and parallel configurations for scaling this prime mover to generate more power
(6) Direct drive or indirect drive configurations with belt or chain drives
(7) Means for providing speed control mechanisms
(8) Means for compacting this prime mover using mini or Micro-structures and gate valves
(9) Means for improving the overall efficiency, such as profiled arms and arm loads

2. A Feeder box (FIG. 3) which provides the interface for navigating the arm loads between different mediums, preferably comprising a combination of Gate valves and/or sensors, one way valves, magnetic doors, automatic shutters, sliding valves and treaded tracks.
(1) Means for providing the leak proof structures such as padding with soft materials
(2) Means for monitoring, such as sensors for tracking the arm loads movement
(3) Means for controlling, such as valves, lids and doors

3. A Side tank (FIG. 5) which facilitates for sustaining one or more forces including buoyant and gravitational forces, with one or more guided slots along with the features for mounting the feeder box claim, filled with a fluidic medium or vacuum that facilitates in aiding claim to make the difference in potential energy levels.
(1) Means for providing leak proof and flexible sealings to mitigate the leakage from side tank, feeder box and arm loads
